(19) United States
(12) Patent Application Publication
(10) Pub. No.: US 2004/0013385 A1
(43) Pub. Date: Jan. 22, 2004

(54) Method of fabricating planar waveguides and devices made by the method

(76) Inventors: Andre Luiz Ribeiro Brennand, Southampton (GB); James Shafto Wilkinson, Southampton (GB)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/447,683

(22) Filed: May 29, 2003

(30) Foreign Application Priority Data
May 31, 2002 (GB) 0212518.5

(51) Int. Cl. G02B 6/10

(52) U.S. Cl. 385/129; 65/425; 65/386

(57) ABSTRACT

Waveguides are fabricated in a variety of silicate glasses by applying electric fields to a substrate at elevated temperatures. The glass has components of at least two alkali or alkaline earth ions with differential mobility rates. A DC electric field is applied to the glass which separates the mobile cations into regions according to their mobility. Each region presents a different refractive index, allowing a waveguide to be formed. This method has been used to produce waveguides with an index increase greater than 10⁻² in soda-lime glass with no external ion source, and the waveguides are buried beneath the substrate surface without an additional step. Waveguides, lenses or other devices requiring spatial variation of refractive index profile can thus be formed by redistribution of ions already in the glass, rather than by supplying ions from an external source.

### BACKGROUND OF THE INVENTION

The invention relates to a method of fabricating planar waveguide devices and other devices by thermally-enhanced field-driven ion drift, and to devices made using the method.

Multicomponent glasses are promising materials for a wide range of advanced integrated optical devices. In particular, efficient Yb/Er energy transfer and high gain for optical amplification, high photosensitivity for grating writing, and high λ⁽³⁾ for all-optical switching, have been demonstrated in multicomponent silicate glasses, the latter promising the realization of high λ⁽²⁾ electro-optic waveguides through thermal poling. In principle, all these phenomena may be combined in one material in which waveguides can be fabricated to realize a low-cost multifunctional integrated optical technology. Before efficiently poled waveguides may be realized in multicomponent glasses, information is needed on the ionic redistribution and refractive index changes occurring when the glass substrate alone is poled. Further, the design of electrodes for poling channel waveguides will require knowledge of the response of the substrate material surrounding the waveguide to the poling process. Margulis et al. showed that channel waveguides could be realized by applying a thermal poling process to a soda-lime glass substrate using a deposited aluminum film anode in which narrow channels were opened by photolithography². Waveguide formation resulted from reduction in the refractive index under the electrode either side of the channel opening, and under the channel as a result of sodium ion depletion because of fringing fields and the evolving current path.

Field-assisted and thermal ion exchange are standard techniques for waveguide fabrication in glasses. Fabrication of buried waveguides typically requires two process steps. For example, a first step of thermal ion-exchange in potassium nitrate followed by a second step of field-assisted ion-exchange in sodium nitrate. With both thermal and field-assisted ion-exchange there are the disadvantages that a molten salt must be used as an ion source and a secondary step is necessary to bury the waveguide.

### SUMMARY OF THE INVENTION

The invention provides a method of fabricating planar waveguides by a constant-current thermal poling procedure in multicomponent glasses rich in alkali or alkaline earth ions. Near the anode, a DC electric field is applied to the substrate to separate the mobile cations into regions according to their mobility. Each region presents a different refractive index, allowing a waveguide to be formed. This method has been used to produce waveguides with an index increase greater than 10⁻² in soda-lime glass with no external ion source, and the waveguides are buried beneath the substrate surface without an additional step.

Buried waveguides with large index elevation (Δn˜0.01) have been realized in a number of glasses (namely soda-lime glass, BK7, crown glass and SFL6) by applying an electric field at elevated temperature. The waveguides are formed simply by redistribution of the ions already in the glass rather than by supplying ions from an external source. The waveguides (or other elements requiring spatial variation of refractive index, such as lenses) form due to the ions drifting at a differential rate under the influence of the electric field causing, for instance, potassium ions to “bunch up” in a region below the glass surface. This bunching causes a local increase in index which is below the glass surface.

Compared with the prior art, buried waveguides are fabricated at lower temperature and in one step without the need of an external ionic source such as a molten salt. The index elevation achieved so far is sufficient to allow low radii of curvature and thus potentially high device integration.

The poling temperatures needed will depend upon the glass used, but temperatures for silicate multicomponent glasses will typically lie in the range 200C-350C. Silicate glasses can typically be considered to be glasses containing about 25 to 75 wt % of silica. To apply the electric field, electrodes can be applied to the top and bottom of the substrate, for example by evaporation of aluminum films. Poling is carried out by applying voltages ranging typically from a few tens of volts at the beginning of the fabrication process to a few kV at the end of the process, with some dependence upon glass substrate thickness. The poling field is typically applied for times up to 2 hours, preferably in vacuum for process repeatability.

Waveguide fabricated according to the invention will be of use for telecommunications and sensing. The invention could also be applied to fabricating other refractive elements such as microlenses, microlens arrays and diffraction gratings.

The method of the invention can be used to fabricate passive and active optical waveguide devices such as a waveguide power splitters, directional couplers, amplifiers, lasers, “lossless splitters”, modulators and all-optical switches.

### BRIEF DESCRIPTION OF THE DRAWINGS

For a better understanding of the invention and to show how the same may be carried into effect reference is now made by way of example to the accompanying drawings.

FIG. 1 Fabrication apparatus.

FIG. 2 Modal effective indices against poling time.

FIG. 3 Concentration distributions of mobile ions under the anode after poling with 20 μA a) for 120 minutes in soda-lime glass at 200° C. and b) for 90 minutes in BK7 at 300° C. The mode intensity profile of the resulting waveguide is also shown.

### DETAILED DESCRIPTION

The effects of constant current thermal poling of soda-lime glass substrates is now described. The experiments used uniform circular deposited electrodes. It was found that waveguides were formed directly under the anode. Cross sectional compositional profiling by X-ray Energy Dispersion Analysis (EDX) showed that, while the surface is depleted of sodium ions, a buried region of elevated calcium and magnesium ion content (referred to as the accumulation region) forms beneath the surface within the Na⁺ depletion region. Waveguide mode profiling by near-field imaging confirmed that the waveguide mode is buried and that it is localized within this accumulation region. The modal effective indices of the slab waveguides fabricated in soda lime glass were measured at a wavelength of 633 nm and related to the duration of the process. Waveguides have also been fabricated in BK7, SFL6 and Crown glasses using this technique, demonstrating its wide applicability to glasses rich in alkalis or alkaline earths.

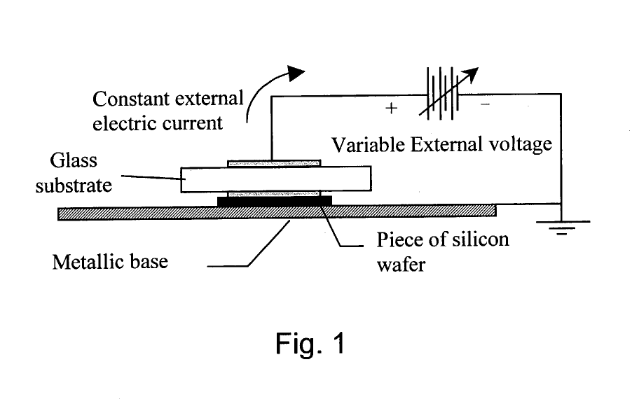

Three soda-lime glass substrates (Fisher Premium), 25 mm square by 1 mm thick, were cleaned, and circular 7 mm diameter aluminum electrodes of thickness 400 nm were deposited centrally on both faces by vacuum evaporation through a shadow mask. To apply an electric field at elevated temperature, each sample was placed in a holder with the cathode pressed onto a silicon wafer and a high-voltage (HV) supply was connected between the anode and the silicon wafer, as shown in FIG. 1. The assembly was placed in a vacuum chamber with a radiant heater, the chamber was pumped to below 3×10⁻⁶ mbar, and the sample was heated until it reached equilibrium at 200° C. The HV supply was then turned on and a variable voltage was applied to maintain a constant external current of 20 μA for the process time. Each sample was cooled down to room temperature with a constant voltage applied equal to that achieved at the end of the poling process. The external current fell to zero approximately 2 minutes after commencement of cooling. The temperature, current and the applied voltage were continuously recorded from the application of the initial voltage until the samples reached room temperature.

The soda lime samples were processed for 60, 90 and 120 minutes. The voltage applied to maintain a constant current of 20 μA rose approximately linearly over the entire duration, in agreement with results reported by Garcia et al³. In all cases the initial value was approximately 90V and the final values attained were 1.36 kV, 2.05 kV and 2.51 kV after 60, 90 and 120 minutes respectively. This shows that the voltage drop through the negatively charged layer depleted of sodium ions³ increases linearly with the charge transported.

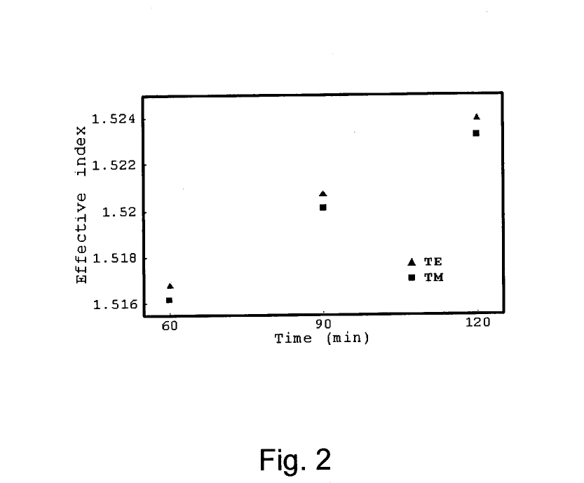

Following the poling process, the electrodes were removed from all samples using a commercial aluminum etchant and the anode surface region was observed under white light illumination. In each case, the poled region appeared uniformly colored, exhibiting a red to pink hue, indicating the formation of a layer with a uniform refractive index different from that of the bulk. Waveguide modes were detected in the region below the removed anode using the standard prism coupling technique, indicating a region of increased refractive index near the surface. FIG. 2 shows the effective indices, N_{eff}, measured at a wavelength of 633 nm in the center of the poled region, with an error of ±2×10⁻⁴, for the TE and TM polarizations. The waveguide modes show increasing effective indices with poling time, and the TE-polarized modes showed slightly higher effective indices than TM-polarized modes, as would be expected in a stressless isotropic material. If the substrate index is taken to be 1.512 at this wavelength, then the increase in index due to this process is greater than 10⁻².

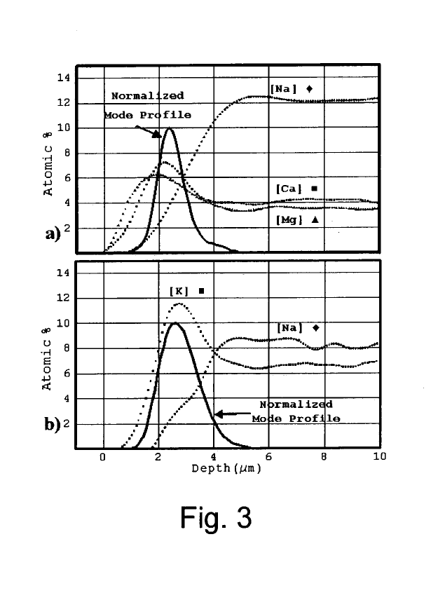

To study how the waveguides had been formed, the samples were diced and end-polished to allow EDX line scans of the cross-sectional concentration profiles and near-field measurements of the waveguides modal profiles. The depth distributions of sodium, calcium and magnesium ions under the anode, obtained by EDX for the sample poled in vacuum for 120 minutes, are shown in FIG. 3a where the surface is at 0 μm. It can be seen that the sodium ions are strongly depleted at the surface, as expected, and that the Ca²⁺ and Mg²⁺ ions have become depleted at the surface but concentrated close to the edge of the sodium depletion region. The calcium ion accumulation agrees with Lepienski's compositional measurements on poled soda-lime glass Ca²⁺ and Mg²⁺ ions are so much less mobile than Na⁺ ions that they do not participate in normal ion-exchange and field-assisted ion-exchange processes in soda-lime glass. We believe that the drift of the much less mobile Ca²⁺ and Mg²⁺ ions, in this case, is due to the high electric field built up in the sodium depletion region during poling. The drift of Ca²⁺ and Mg²⁺ ions is restricted to the depletion region since the electric field that drives the Na⁺ ions in the highly conductive bulk glass is too low to drive the Ca²⁺ and Mg²⁺ ions. The accumulation of Ca²⁺ and Mg²⁺ is caused by this differential drift that forces the Ca²⁺ and Mg²⁺ ions to occupy vacancies left by depleted Na⁺ ions, but does not allow them to penetrate further into the bulk.

Light from a He—Ne laser at a wavelength of 633 nm was coupled into the waveguides using a monomode optical fiber and their modal intensity profiles were measured by imaging onto a CCD camera using a 63×objective. The position of the substrate surface was determined by imaging the illuminated end face of the waveguide with the same set up. These measurements were calibrated using a micrometric graticule replacing the waveguide edge. An unpolarized mode profile obtained by the imaging setup is superimposed on FIG. 3, with the scales and the absolute positions of the depth axis aligned with an accuracy of ±0.25 μm, showing that the waveguide mode is buried substantially beneath the substrate surface and that it is localized in the accumulation region of high Mg²⁺ and Ca²⁺ concentration. The overlap of the mode profile and the accumulation region supports the view that the packing of the two alkaline earth components of the glass creates a waveguiding layer with a higher refractive index than that of the depletion region and the bulk glass.

Buried waveguides were also found in BK7 glass processed at 300° C. and under the same electrode and current conditions. The ionic concentration and mode profiles of a sample processed for 90 minutes are shown in FIG. 3b. A pronounced accumulation peak of K⁺ ions in the sodium depletion region forms a waveguide buried under a layer depleted of sodium and potassium, and waveguiding was confirmed by prism-coupling. The confinement of the waveguide mode to the potassium-rich region beneath the glass surface confirms that the waveguide is formed in the accumulation region rather than by simple compaction of the glass. From these results we expect that waveguides may be formed in this way in many silicate glasses containing more than one alkali or alkaline earth ion with significantly different mobilities. Preliminary measurements have shown that poling of SFL6 and crown-type glasses for 90 minutes also yields waveguide modes and we believe that these waveguides were also formed by differential drift between Na⁺ and other less mobile ions in these glasses.

In summary, we have shown that planar waveguides may be created by applying a “poling” procedure with uniform electrodes to a homogeneous glass substrate containing more than one species of alkali or alkaline earth ion. The index increase produced by this method is greater than 10⁻² for soda-lime glass, and the waveguides are buried beneath the substrate surface without any additional step. The buried waveguides are formed at the lower edges of the Na⁺ depletion regions by the accumulation of the less mobile ions, K⁺ in BK7, and Ca²⁺ and Mg²⁺ in soda-lime glass. This technique is expected to be applicable to a wide range of multicomponent glasses and may contribute to the realization of poled glass waveguides for nonlinear applications.

For completeness, typical compositions of the various glasses suitable for use with the invention, including those referred to above, are now discussed:

Soda-Lime Glass

Soda-lime glass usually contains 60-75 wt % SiO₂, 12-18% wt % Na₂O and 5-12 wt % CaO.

### EXAMPLE COMPOSITION

SiO₂ 72 wt %

Na₂O 15 wt %

CaO 6 wt %

Al₂O₃ 1 wt %

K₂O 1 wt %

MgO 4 wt %

Traces 1 wt %

Borosilicate Glass

A borosilicate glass is a glass with a major component of silica, for example 25 to 75 wt %, and also containing at least 5 wt % boric oxide, and normally between 10 wt % and 20 wt % of alkali oxides or alkali-earth oxides.

BK7 is an example of a borosilicate glass and has approximately the following composition:

SiO₂ 70 wt %

B₂O₃ 10 wt %

Na₂O 8.5 wt %

K₂O 8.5 wt %

BaO 2.5 wt %

Traces 1 wt %

In BK7, the K and Na ions provide the necessary differential mobility.

B270—an Example of a Crown Glass

The approximate constituents of B270 are:

SiO₂ unknown wt %

Na₂O 11 wt %

K₂O 3 wt %

CaO 4 wt %

Precise details of the composition are a trade secret of Schott.

SFL6

This glass is a substitute for the lead glass SF6 and contains Na and K which provide the differential ion mobility needed for the invention. The precise composition of SFL6 is a trade secret of Schott.

Other Glasses

In addition to the silicate glasses tested, the method of the invention is expected to work for phosphate glass, tellurite glass, bismuthate glass, fluoride glass, etc. The most important prerequisite is that the glass must have two ions which are mobile with applicable fields and temperatures, and which have significantly different mobilities. Na, K, Li, Ag, Mg and Ca are examples of ions that may be mobile, either as the higher or lower mobility species, in silicate and other glasses. For example, K could be the lower mobility ion species in conjunction with Na, and the higher mobility ion species in conjunction with Ca.

It will be appreciated that although particular embodiments of the invention have been described, many modifications/additions and/or substitutions may be made within the spirit and scope of the present invention.

### REFERENCES

1. J. S. Aitchison, J. D. Prohaska and E. M. Vogel, “The nonlinear optical properties of glass”, Metals Materials and Processes 8, 277-290 (1997).

2. W. Margulis and F. Laurell, “Fabrication of waveguides by a poling procedure,” Appl. Phys. Lett. 71,2418-2420 (1997).

3. F. C. Garcia, I. C. S. Carvalho, W. Margulis and B. Lesche, “Inducing a large second-order optical nonlinearity in soft glasses by poling,” Appl. Phys. Lett. 72, 3252-3254 (1998).

4. C. M. Lepienski, J. A. Giacometti, G. F. Leal Ferreira, F. L. Freire Jr. and C. A. Achete, “Electric field distribution and near-surface modifications in soda-lime glass submitted to a DC potential,” J. Non-Cryst. Solids 159, 204-212 (1993).

What is claimed is:

1. A fabrication method, comprising:
providing a glass containing first and second ion species of higher and lower mobility respectively; and
applying an electric field to the glass at elevated temperature to create a depletion region of the higher mobility ion species within which the lower mobility ion species is mobile, so that the lower mobility ion species moves to accumulate at one edge of the depletion region and thereby form a buried region of elevated refractive index.

2. The method of claim 1, wherein the higher mobility ion species is Na.

3. The method of claim 1, wherein the lower mobility ion species is Ca.

4. The method of claim 1, wherein the lower mobility ion species is Mg.

5. The method of claim 1, wherein the lower mobility ion species are Ca and Mg.

6. The method of claim 1, wherein the lower mobility ion species is K.

7. The method of claim 1, wherein the glass is a silicate glass.

8. The method of claim 1, wherein the glass is a borosilicate glass.

9. The method of claim 1, wherein the glass is a soda-lime glass.

10. The method of claim 1, wherein the glass is a crown glass.

11. The method of claim 1, wherein the higher mobility ion species is Na, the lower mobility ion species are Ca and Mg, and the glass is a soda-lime glass.

12. The method of claim 1, wherein the higher mobility ion species is Na, the lower mobility ion species is K, and the glass is a borosilicate glass.

13. A planar waveguide device, comprising: a glass substrate having a surface and containing first and second ion species of higher and lower mobility respectively, wherein the lower mobility ion species has a concentration that peaks at a depth below the surface of the glass substrate at which depth the concentration of the higher mobility ion species is depleted, thereby to form a local region of elevated refractive index.

14. The device of claim 13, wherein the higher mobility ion species is Na.

15. The device of claim 13, wherein the lower mobility ion species is Ca.

16. The device of claim 13, wherein the lower mobility ion species is Mg.

17. The device of claim 13, wherein the lower mobility ion species are Ca and Mg.

18. The device of claim 13, wherein the lower mobility ion species is K.

19. The device of claim 13, wherein the glass is a silicate glass.

20. The device of claim 13, wherein the glass is a borosilicate glass.

21. The device of claim 13, wherein the glass is a soda-lime glass.

22. The device of claim 13, wherein the glass is a crown glass.

23. The device of claim 13, wherein the higher mobility ion species is Na, the lower mobility ion species are Ca and Mg, and the glass is a soda-lime glass.

24. The device of claim 13, wherein the higher mobility ion species is Na, the lower mobility ion species is K, and the glass is a borosilicate glass.
